(19) United States
(12) Patent Application Publication
(10) Pub. No.: US 2014/0012723 A1
(43) Pub. Date: Jan. 9, 2014

(54) METHOD OF AND SYSTEM FOR MANAGING AN ASSET

(71) Applicant: Markus Lobmaier, Wien (AT)

(72) Inventor: Markus Lobmaier, Wien (AT)

(21) Appl. No.: 13/981,736

(22) PCT Filed: Feb. 3, 2012
(86) PCT No.: PCT/EP2012/051871

§ 371 Date: Jul. 25, 2013

(30) Foreign Application Priority Data
Feb. 4, 2011 (EP) PCT/EP2011/051690

(51) Int. Cl. G06Q 20/04

(52) U.S. Cl. CPC G06Q 20/04
USPC 705/35

(57) ABSTRACT

In a method of managing an asset the following steps are performed: receiving a request to transfer a part of said first asset from a first user to at least a second user at a system, wherein said request is received via an over-the-air communication with a first mobile device in which a first asset is stored, wherein the first mobile device is assigned to the first user, and assigning at said system: —) a remaining part of said first asset to the first user, and —) said part of the first asset, which part was requested to be transferred to the second user.

### FIELD OF THE INVENTION

The invention relates to a method of managing an asset.

The invention further relates to a system for managing an asset.

The invention further relates to a mobile device for storing an asset.

### BACKGROUND OF THE INVENTION

A method of managing an asset represented by a digital voucher is e.g. disclosed in “Offline NFC Payments with electronic Vouchers” by Gauthier Van Damme et al. NFC is the abbreviation for Near Field Communication. The basic structure of a system for deploying said method consists of three types of actors, namely an issuer that issues the digital voucher, users or in other words beneficiaries that use an NFC enabled mobile phone to benefit from the voucher, and owners of payment terminals that are herein termed affiliates.

Such a system implements the following types of transactions between actors, namely: a Short Message Service (SMS) based on an unconfirmed transaction from the issuer to a beneficiary, which leads to a voucher stored in the mobile phone of the beneficiary; an NFC or Radio Frequency Identification (RFID) or SMS based transaction of a voucher from said mobile phone to another mobile phone of another beneficiary; a payment transaction for transferring a voucher from one mobile phone of a beneficiary to a payment terminal; clearance between the affiliate and the issuer, which happens over a secured (possibly dedicated) network.

A voucher used in said system represents an asset, e.g. an amount in Eurocent, and consists of other digital values that represent e.g. a serial number, a validity period, a status type and so on.

The known method and system shows the problem that only the entire voucher, which means the entire asset, can be consumed/used by a beneficiary. In this constellation the beneficiary is the creditor while the affiliate and/or issuer is the debitor. When the voucher is transferred from one mobile phone to another mobile phone the transfer occurs in fact between two creditors of the affiliate or issuer.

Therefore it is an object of the present invention to overcome the aforementioned problem and to provide an improved method of managing an asset represented by a voucher, an improved system for managing an asset represented by a digital voucher, and an improved mobile device for storing a voucher that represents an asset, so that a more flexible use of the asset represented by the voucher can be achieved.

### SUMMARY OF THE INVENTION

The object as defined above is achieved by a method of managing an asset, the method comprises the steps of receiving a request to transfer a part of a first asset from a first user to at least a second user at a system, wherein said request is received via an over-the-air communication with a first mobile device in which the first asset is stored, wherein the first mobile device is assigned to the first user, and assigning by the aid of said system or at said system: —) a remaining part of said first asset to the first user, and —) said part of the first asset, which part was requested to be transferred, to the second user.

Further to this, the object is achieved by a system for managing an asset, the system comprises: an interface stage for receiving a request to transfer a part of said asset from a first user to a second user, wherein said request is received via an over-the-air communication with a first mobile device, in which said first asset is stored, wherein the first mobile device is assigned to the first user, and an assigning stage for assigning: —) a remaining part of said first asset to the first user, and —) said part of the first asset, which part was requested to be transferred, to the second user.

This object is also achieved by a computer program (product) comprising software code that is adapted to perform the steps of the method of managing an asset according to the invention when executed on a programmable device, e.g. on a computer of the system according to the invention.

The object is also achieved by a mobile device, in particular a mobile phone, for storing an asset, the mobile device comprises: an over-the-air communication stage for performing over-the-air communication, and a memory stage for storing —) a first asset, and —) an application for sending a request to transfer a part of said first asset from a first user to a second user, wherein said request is sent via an over-the-air communication to a system.

An asset may represent a deposit of a monetary type, e.g., EUR 100.− or more generic a value in any currency, or of a material type, e.g. a number (e.g. 10) of bottles of a particular wine, or of a service-related type, e.g. a number (e.g. 15) of physiotherapy treatments, or the like. The deposit can be acquired by purchase. The asset is represented by digital data, which are stored or transferred between devices.

According to a particular embodiment of the invention the asset may be represented by a digital voucher. The digital voucher may be acquired by purchase as a cash value voucher, a money equivalent voucher, a monetary value equivalent voucher, a deposit voucher, a purchase voucher or and the like. Such a type of voucher is different from a discount voucher, which can only be used as a whole to purchase a product or a service for a reduced price.

A digital voucher—in its simplest form—may be a dataset, wherein data represent in a digital form a unique identification number for identifying the voucher. Such an identification may be achieved e.g. by means of a GS1-128 Bit Code as the unique identification number, which is commonly used for bar codes printed on paper vouchers. The voucher, or more particular, the asset represented by the voucher is identified by means of the GS1-128 Bit Code. But also any other coding, e.g. known in the domain of barcodes, may be applied.

Knowledge about the unique identification number and the asset assigned to it may be stored remotely from the storage of the voucher. Typically the issuer of the voucher, e.g. a service provider or in other words the owner of the voucher program like BIPA or BILLA, both being part of the REWE group, or any voucher issuing retail chain, holds the information about the link between the unique identification number and the asset assigned with it. Such an issuer may also hold the information about the link between the unique identification number and the beneficiary to whom the voucher is assigned. The beneficiary typically signs up for a membership of a loyalty program, sometimes also termed voucher program, before the beneficiary can benefit (receive, transfer, spend, collect, . . . ) from vouchers. Therefore the beneficiary is a member of the voucher program of which the service provider—as defined below—is the owner. Vouchers are typically provided as a remuneration of earlier purchase of goods or services or may be assigned to the beneficiary on behalf of another beneficiary, e.g. as a present for the earlier mentioned beneficiary.

However, the dataset of a voucher may also be structured differently and may comprise, e.g. beside the unique identification number, further elements, e.g. validity period information and/or status type information (e.g. transaction pending, spent, expired) and/or a digital signature (e.g. of an issuer) and/or the asset available.

In this context the method of managing said asset extends to a method of managing said digital voucher that represents said asset. Here the method comprises the steps of: a) receiving a request to transfer a part of said asset from a first user to at least a second user, wherein said request is received at a system via an over-the-air communication with a first mobile device, in which first mobile phone a first digital voucher representing said asset is stored and the first mobile device is assigned to the first user, and b) and assigning by the aid of said system or at said system:—b1) a second digital voucher to said first user, wherein the second digital voucher represents the remaining part of the asset of said first voucher, and—b2) a third digital voucher to said second user, wherein the third digital voucher represents said part of the asset, which part was requested to be assigned, to the second user.

Further to this, in the above-mentioned context the system for managing an asset extends to a system for managing said digital voucher that represents said asset. The system comprises: a) an interface stage for receiving a request to transfer a part of said asset from a first user to at least a second user, wherein said request is received via an over-the-air communication with a first mobile device, in which a first digital voucher is stored, wherein the first mobile device is assigned to the first member, and b) an assignment stage for assigning:—b1) a second digital voucher to said first user, wherein the second digital voucher represents the remaining part of the asset of said first voucher, and—b2) a third digital voucher to said second member, wherein the third digital voucher represents said part of the asset, which part was requested to be assigned, to the second member.

Further to this, in the above-mentioned context the mobile device for storing a digital asset extends to a mobile device for storing a digital voucher that represents said asset. The mobile device comprises: an over-the-air communication stage for performing over-the-air communication, and a memory stage for storing —) a first digital voucher, and —) an application for sending a request via an over-the-air communication to a system according to the invention to transfer a part of said asset from a first user to a second user of said voucher program.

In particular the voucher may belong to a voucher program and it is required that at least said first user is a first member of the voucher program in order to request said transfer. More particular also said second user must be a second member of said program in order to receive and to use the voucher received.

The digitally represented asset or the digitally represented voucher, as the case may be, when in use in a mobile device ecosystem, may be stored in the secure element (SE) of a mobile device, e.g. a mobile phone, a tablet PC or the like. An SE may be a Universal Integrated Circuit Card (UICC), an Embedded Secure Element, and a Secure Memory Card like a microSD Card, or any other integrated circuit that satisfies the need for ongoing security and confidentiality of sensitive applications and data downloaded to and stored on a mobile device, e.g. an NFC enabled mobile phone, for performing contactless NFC based business transactions. The Universal Integrated Circuit Card or the microSD Card are designed to be plugged into said mobile device in order to provide several functionalities but also to enable the mobile device, e.g. NFC enabled mobile phone, to access and use its secure element properties/functionalities.

In the following reference is made to the “GlobalPlatform's Proposition for Near Filed Communication Mobile: Secure Element Management and Messaging—White Paper, April 2009”, herein referred to as GPWP, and the GlobalPlatform Card Specification Version 2.1.1, March 2003, herein referred to as GPCS. In the following, for the sake of alignments with de-facto standards, definitions provided by the GPCS and/or the GPWP are deployed as far as possible and useful.

Within the SE a security domain is provided, which shall mean an on-card entity providing support for the control, security, and communication requirements of the application provider. “Application provider” shall mean an entity that owns an application and is responsible for the application's behaviour. According to the GPWP the application provider may be a service provider. “Service provider” shall mean an entity that provides contactless services to the customer, e.g. NFC based services. Without any claim of completeness a service provider may be a bank, a public transport company, a loyalty program owner etc. as published in Mobile NFC Services, Version 1, of the GSM Association. The service provider may develop its own application or may outsource the development of such an application to an application developer. “Application” shall mean an instance of an executable module” after it has been installed and made selectable. “Executable module” contains the on-card executable code of a single application present within an executable load file. “Executable load file” shall mean an actual on-card container of one or more application's executable code (executable modules).

In contrast to already mentioned short-range communication methods, e.g. RFID or NFC, a long-range communication method shall be understood as an over-the-air communication. Such long-range communication methods may be provided e.g. according to Global System for Mobile Communications (GSM) or Universal Mobile Telecommunications System (UMTS) specification(s) and the like, commonly used in telecommunication networks typically operated by mobile network operators (MNO), or e.g. according to Wireless Local Area Network (WLAN) specifications and the like, commonly used in wireless computer networks, all of which allowing wireless access to Internet services.

According to the invention, the system may be realized by one or more computers or servers, which are partly or entirely operated in-house of the over-the-air manager. On such a computer a software is loaded in form of said computer program and executed to perform the steps of the method according to the invention. A further interface stage connects the computer(s) with an appropriate over-the-air communication stage, which may be operated in-house of the over-the-air manager or outsourced. The interface stage may also provide appropriate Internet connectivity to connect the computer(s) with databases operated on the side of an MNO or on the side of a service provider. This connectivity may be used to retrieve information regarding the mobile devices available in the mobile communication network of the MNO or to retrieve information regarding the vouchers stored on said mobile devices, so that access to the mobile devices is possible and the vouchers can be managed on the mobile devices by the system.

The mobile device may be realized as a mobile phone having a display as physical user interface. The mobile phone may be of the smart phone type on which applications from different application providers can be loaded. In the present context of the invention an application is loaded that belongs to or is released on behalf of the service provider. It may be created and distributed by the over-the-air manager and provides features for interacting with a user of the mobile phone and for utilization of the over-the-air communication means, e.g. UMTS communication means, in order to communicate with the system of the over-the-air manager. The application utilizes the physical interface to display its virtual interface in order to interact with the user of the mobile phone.

The measures according to the invention allow the partial use of an asset or of a voucher, as the case may be. The original asset or voucher is owned by an owner—the first user. The owner transmits said part to a beneficiary, sometimes also termed recipient or assignee. The transmission is performed via an over-the-air communication. The system according to the invention performs or controls the process of assigning parts of the asset or the voucher to the original owner and the beneficiary. Here the splitting of the original asset or voucher is performed for the benefit of two or more beneficiaries. This process is different from a conventional consumption of the asset or the voucher in form of purchasing goods or services because the process does not involve a conversion of said asset or voucher in goods or services. If the asset or the voucher is consumed—entirely or party, the involvement of a beneficiary in form of a creditor and a service provider or retailer and the like in form of a debitor would be the case.

In particular the measures according to the invention allow an original/initial asset to be split in portions and to assign each portion to individual beneficiaries. By means of the invention it is e.g. possible to use a EUR 100.− digital voucher stored in the first mobile device of a first beneficiary and to assign e.g. only EUR 20.− in form of another digital voucher to a second beneficiary, while the remaining EUR 80.− stay in form of a digital voucher in the property of the first beneficiary stored in its first mobile device.

Advantageously this transaction can be performed without the need to spend the EUR 100.− voucher at a payment terminal and to manually utilize the asset of EUR 100.− in form of cash to buy a second voucher of the value of EUR 80.− and a third voucher of only EUR 20.−, wherein the second voucher shall remain in the property of the first beneficiary and the third voucher shall be given to the second beneficiary. In fact the invention avoids this cumbersome process of spending the original voucher at a particular terminal and purchasing other vouchers to be assigned to different beneficiaries.

In a further example, the original owner may hold a value of Euro 100.− as asset stored in an electronic purse such as QUICK money cards used in Austria. The owner may request to transfer a voucher of a value of Euro 13.− to purchase a particular perfume at a perfumery, e.g. BIPA, to a beneficiary. The system according to the invention receives such a request, puts the original asset of Euro 100.− into a pending state at the mobile device of the original owner, converts the value of Euro 13.− into a voucher, submits the voucher to the mobile device of the beneficiary where storage is confirmed, and stores the remaining asset of Euro 87.− in the mobile device of the original owner and permanently deletes the pending asset of Euro 100.−. In general, the system according to the invention may also perform a transparent conversion of the asset from one type, e.g. money or cash, into another type, e.g. deposit voucher or money equivalent voucher, or the other way around.

In contrast to this cumbersome process the invention enables a smooth peer-to-peer (mobile device to mobile device) forwarding of only a fraction of an asset of an original voucher by utilization of the service of the system according to the invention. The system performs the step of assigning of parts of the original digital asset. The forwarding can be performed from any location where an over-the-air service is available. As such the underlying mechanism of forwarding is insofar transparent for the user/beneficiary as he/she never comes in contact with any other entity different than the mobile device. Hence, independent of a terminal location and/or independent of a service provider infrastructure it is possible for the first time ever to forward a fraction of an asset or an original voucher, while the integrity of a service provider specific voucher program is secured, in particular by managing functions/properties of the system according to the invention. This means that for the entire transaction only vouchers are used: hence any deviation from the asset-representation medium of vouchers is avoided.

The dependent claims and the subsequent description disclose particularly advantageous embodiments and features of the invention. The dependent claims of the system and the mobile device may be further developed according to the dependent claims of the method according to the invention. Advantages and effects mentioned in the context of dependent claims of the method do as well apply to the dependent claims of the system and the mobile device.

According to a further aspect of the invention the step of assigning is performed independently by the system, e.g. by an over-the-air manager, or in cooperation with a service provider, e.g. as the owner of said voucher program.

If performed independently, advantageously, the over-the-air manager itself may be the owner of the voucher program or the over-the-air manager may be appointed as trusted service manager to independently manage the entire voucher program. In the latter case the trusted service manager may have full access to details of the voucher program and to sensitive customer information.

If the step of assigning is performed in cooperation, the service provider may typically not disclose transparent customer data or details of the voucher program to the over-the-air manager as trusted service manager. In this scenario the service provider utilizes the infrastructure of the trusted service manager, e.g. the access gateways to the mobile devices operated in a mobile network of a mobile network operator, the authorization by the mobile network operator to utilize the secure element of the mobile devices to manage the vouchers on behalf of the service provider. Hence, the service provider operatively outsources the communication with the mobile devices.

In order to effectively assign the assets to the individual beneficiaries, two different processes are envisaged.

According to the first process the step of assigning comprises utilizing a unique digital first identification code of the first asset or voucher for the second asset or voucher, wherein the first identification code was already assigned to the first user. Here, the already existing first identification code is re-used for the second asset or voucher. Consequently, an efficient use of codes is provided. According to this process the simultaneous availability of the first identification code for the first and the second asset or voucher must be avoided by appropriate measures.

In contrast thereto, the step of assigning may also comprise utilizing a unique digital second identification code for the second asset or voucher, wherein the second identification code is newly (for the first time ever) assigned to the first user. Here it is automatically guaranteed that a particular identification code is used only once during the entire lifetime of the asset or voucher program and any ambiguity is avoided. Hence any potential ambiguities related to simultaneous existence of one code for two different asset or vouchers are per se avoided.

Said second asset or voucher is the remaining part of said first asset or voucher.

It is common to both processes that a unique third identification code is utilized for the third asset or voucher, wherein the third identification code is newly (for the first time ever) assigned to the second user.

The third asset or voucher is the part of the first asset or voucher to be transferred.

A further aspect of the invention relates to the topic of avoiding any double spending of assets or vouchers, while the assignment of the assets or vouchers is in progress or was terminated for other reasons. Termination for other reasons may comprise e.g. power supply break down in the mobile device, interruption of communication in the mobile communication network to which the mobile device has/had access, or errors on the server side used at the over-the-air manager or at the service provider, but also other incidents not explicitly specified may be classified as such other reasons. Once termination occurred, appropriate roll back protocols may be executed on the side of the mobile device and/or on the side of the over-the-air manager and/or the service provider in order to reestablish the assignment of assets or vouchers between the beneficiaries as it was the case prior to the occurrence of the termination for other reasons. In order to achieve the aforementioned aspect the step of assigning comprises blocking the first digital asset or voucher from being used until the request to transfer said part of said asset or voucher is successfully completed or terminated for other reasons. This may be achieved by measures applied outside of the mobile device by adjusting a status of the asset or voucher in a database, e.g. operated by the over-the-air manager or of the service provider. This may also be achieved by measures applied inside of the mobile device by adjusting the status of the asset or voucher stored in the secure element of the mobile device. However, the status of the asset or voucher may also be changed within the mobile device and the remote database.

According to a further aspect of the invention the step of assigning is accompanied by checking if the second user is willing to accept to receive said part of the asset or voucher to be transferred, in particular said checking is performed preceding the step of assigning or comprised in the step of assigning, e.g. at the end of a pending assignment of parts of the original asset or voucher. Advantageously, beside potential technical troubles in the step of assigning which are collectively handled in the context of termination for other reasons, also the willingness of a beneficiary to receive a part of the asset or voucher is taken into account, which may be a critical factor for a successful assignment of a part of the asset. This check may be performed by means of communication between the over-the-air manager with the mobile device of the recipient beneficiary. Here preset data in the mobile device may be checked in order to determine the willingness, but also an interaction with said recipient beneficiary may be performed by the aid of an application operated on the mobile device. Consequently, determined by the temporal availability of the recipient beneficiary, said willingness may be determined on the fly, or so to say just in time with only minor delay after the request to transfer said part of the asset or voucher was released. However, if the recipient beneficiary is not immediately available for declaring his/her willingness, the check may be kept on pending e.g. for a pre-determined period like 15, 30 or 60 minutes or even days or weeks, during which period the utilization of that part of the asset that is intended to be transferred is not available to the first beneficiary. After expiration of the pre-defined duration and a lack of confirmation by the recipient beneficiary to accept the pending assignment, the request to assign a part of the asset or voucher is withdrawn. This situation is communicated by the over-the-air manager—in particular by its system according to the invention—back to the mobile device of the first beneficiary and, dependent on the actual status of the step of assigning, the assigning on the side of the first mobile device, the over-the-air manager or the service provider or even on the second mobile device is reversed or the intended (planned) assigning not yet started is deleted. Accordingly, if in the assigning step identification codes for the assets or vouchers were already assigned, such already assigned identification codes may be re-assigned according to the status prior to receiving the request to assign part of the asset or voucher, which also includes deletion of such codes if they are not used.

If after all nothing has inhibited the completion of the step of assigning the method also comprises—according to a preferred embodiment—the step of submitting from said over-the-air manager via an over-the-air communication with a second mobile device said third asset or voucher to the second mobile device and storing it in the second mobile device, wherein the second mobile device is assigned to the second member. The successful processing of the original request to assign a part of the asset or voucher may thereafter be indicated on the user interface of the mobile device of the first user as well as on the user interface of the mobile device of the second user. Thereafter, or simultaneous thereto, also the service provider may be informed about the successful re-assignment of the parts of the asset and may set its internal status to make the different assets available for consumption for both beneficiaries e.g. at its NFC terminals. However, the step of assigning may also comprise the step of submitting the said third asset or voucher to an Internet based account of the second user, from where it can be utilized for Internet related e-commerce based consumption of goods and services.

According to a further aspect of the invention the step of receiving said request comprises collecting at least one first identification item to identify said first user. The first identification item allows to check on the side of the over-the-air manager or on the side of the service provider if the enquiring partner is an active member of the voucher program or an active member of a payment service provider (providing e.g. Bankomat, VISA or Paypal services or the like) and if the asset or voucher, or more particular the asset assigned to it, can be utilized to be split in parts. The first identification item may be a unique identification code of its mobile device, e.g. the mobile phone number of the first user, and/or a unique application identification code that identifies the application operated on its mobile device, and/or a unique identification number of a secure element of its mobile device, and/or its user identification e.g. for the voucher program.

Advantageously after the identity of the first user had been checked and confirmed by the service provider or by the over-the-air manager and its membership to the respective program or to the payment service provider was confirmed and the availability of the asset or the voucher was confirmed, the step of assigning comprises collecting of at least one second identification item to identify said second user. Upfront to collecting the second identification item the second user may be identified to the over-the-air manager or the service provider by means of e.g. its telephone umber or its e-mail address, and/or other items known to the first user. Based on this initially available recipient beneficiary information the over-the-air manager or the service provider may check the existence of the indicated recipient beneficiary as active member of its voucher program or its payment services. Provided that it is affirmed that the recipient beneficiary is a second member of the voucher program, the over-the-air manager or the service provider collects from its database the second identification item(s) required to perform the assignment. The second identification item may be a unique identification code of the mobile device of the second user, e.g. the mobile phone number, and/or a unique application identification code that identifies the application operated on its mobile device, and/or a unique identification number of a secure element of its mobile device and/or its user identification e.g. for the voucher program or service program.

It may also be possible that only the first user is a member of a voucher program or payment service and that the indicated second user—e.g. indicated by means of its phone number—is invited to join the voucher program or payment service upfront to receive the asset or the voucher to be transmitted to him or her. As a precondition to benefit from such an asset or voucher to be received, the second user must be a member or must accept to become a member to such a program or service. This feature can be used to the advantage of the service provider to generate new members.

Other objects and features of the present invention will become apparent from the following detailed descriptions considered in conjunction with the accompanying drawings. It is to be understood, however, that the drawings are designed and the description shall only be used for the purposes of illustration of the invention and not as a definition of the limits of the invention.

### BRIEF DESCRIPTION OF THE DRAWING

In the drawing:

FIG. 1 schematically shows an ecosystem for mobile services,

FIG. 2 schematically visualizes a state diagram of a method according to the invention performed in the ecosystem according to FIG. 1,

FIG. 3 schematically displays a system according to the invention, and

FIG. 4 schematically illustrates a mobile device according to the invention.

### DETAILED DESCRIPTION OF EMBODIMENTS

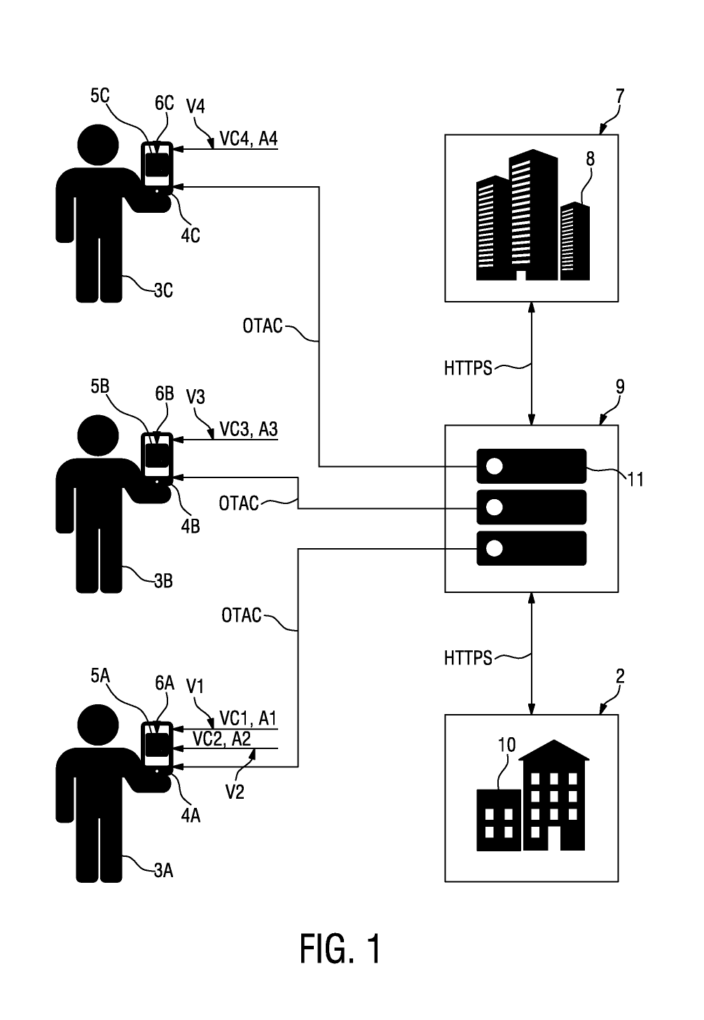

In FIG. 1 an ecosystem 1 for mobile services is depicted. In the present context the mobile service under discussion relates to a loyalty program. A service provider 2 operates a loyalty program in form of a voucher program to which a number of members, e.g. a first member 3A, a second member 3B and a third member 3C, have signed up.

Each member 3A, 3B and 3C owns a mobile device in the form of a mobile phone, e.g. a first mobile phone 4A, a second mobile phone 4B and a third mobile phone 4C. The mobile phones 4A, 4B and 4C are activated and operated in a mobile communication network according to the UMTS standard. Such mobile network communication is herein termed over-the-air (OTA) communication OTAC and is performed by over-the-air communication means of the mobile phones 4A to 4C. Each mobile phone 4A to 4C is equipped with a secure element, abbreviated as SE, herein numbered as first SE 5A, second SE 5B and third SE 5C. Each SE 5A to 5C is assigned a unique secure element identification code.

Each SE 5A to 5C is equipped with an application, herein numbered as first application 6A, second application 6B and third application 6C, to utilize vouchers of the voucher program. Although each application 6A to 6C basically provides identical features, each application 6A to 6C is assigned a unique application identification code. Similar to the applications 6A to 6C also vouchers are stored in the SE 5A to 5C and the respective application 6A to 6C has access to the vouchers stored on its respective SE 5A to 5C.

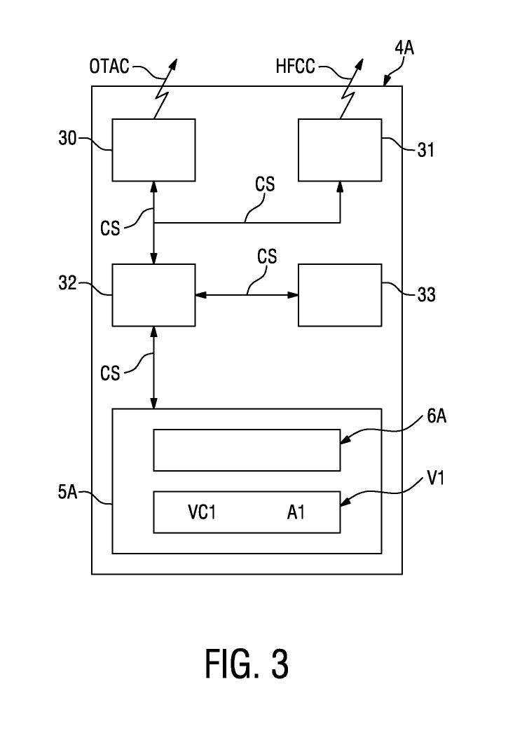

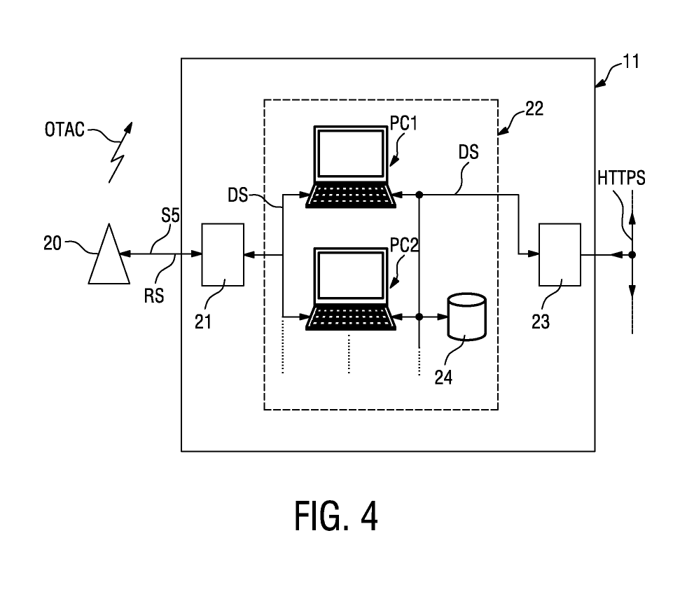

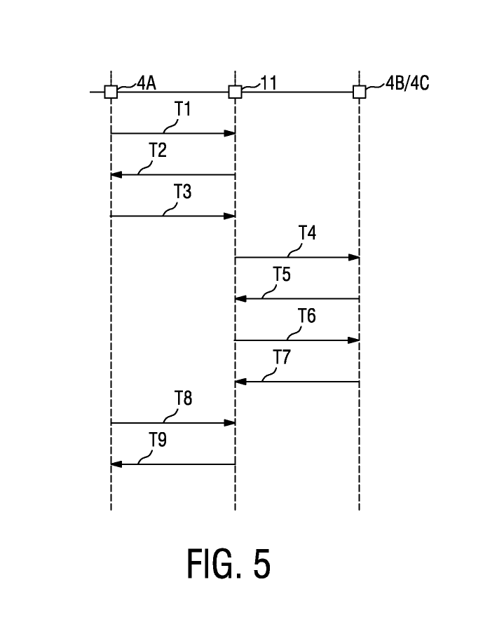

The mobile phones 4A to 4C are also equipped with NFC-devices so that the vouchers can be consumed at NFC enabled terminals in shops of the service provider during an NFC communication NFCC with such terminals (not show in FIG. 1 but indicated in FIG. 3).

The mobile communication network as shown in FIG. 1 is operated by a mobile network operator 7, abbreviated MNO 7. The MNO 7 holds information for identifying each member 3A to 3C and its mobile phone 4A to 4C. Such information is available in form of a mobile device identification code and/or user identification code and/or secure element identification code and other accompanying date stored and managed in a first digital data management device 8, herein abbreviated as first device 8, operated by the MNO 7.

A further entity in the ecosystem 1 is an over-the-air manager 9, abbreviated as OTA manager 9, acting on behalf of the MNO 7 and the service provider 2. The OTA manager 9 is trusted by the MNO 7 to access and modify contents stored in the SE 5A to 5C. In this regard the over-the-air manager 9 is allowed to save and manage the applications 6A to 6C in the SE 5A to 5C. Therefore the OTA manager 9 has access to SE 5A to 5C. The OTA manager 9 is also trusted by the service provider 2 to manage the vouchers by the aid of the applications 6A to 6C in the mobile phones 4A to 4C. In the present embodiment it is assumed that the OTA manager 9 has developed the application 6A to 6C on behalf of the service provider 2, but also a third party developed application may be used.

The service provider 2 operates a second digital data management device 10, herein abbreviated second device 10. By means of the second device 10 data for identifying the members 3A to 3C of the voucher program, their shopping behaviour, their individual turn over, and other data of business relevance are stored or managed. By means of the second device 10 also digital vouchers of the service provider's voucher program are managed. Each digital voucher represents an asset, e.g. an amount of money to be spent in shops of the service provider only.

The OTA manager 9 operates a digital data management system 11, herein abbreviated as system 11. The system 11 comprises a number of computers and appropriate input and output means, all of which are not depicted in details in FIG. 1, but shown in FIG. 3. The system 11 shown in FIG. 3 has access to over-the-air communication means 20 for performing an over-the-air communication with the mobile phones 4A to 4C. Such over-the-air communication means 20 may comprise send and receive amplifiers and antennas or the like, which are commonly known and therefore neither explained nor depicted in details.

The system 11 comprises a first interface stage 21 for an over-the-air communication OTAC during which send signals SS and receive signals RS are exchanged with the means 20. The system further comprises an assignment stage 22 for assigning digital vouchers according to the method of the invention as explained in details below. The assignment stage 22 comprises a number of computers PC1 and PC2 of which only two are visualized. The computers PC1 and PC2 are coupled to the first interface 21 and the second interface 23 and also to a mass storage (database) 24. The mass storage may store data regarding the mobile phones 4A to 4C, access codes for accessing the secure elements 5A to 5C and other user specific data. Also data related or relating to the members 3A to 3C of the voucher program are stored and linked with the mobile phones 4A to 4C or the secure elements 5A to 5C, as the case may be. During operation data signals DS are exchanged between the entities 21, PC1, PC2, 23 and 24. But also the computer program according to the invention may be stored in the mass storage and loaded into the computers PC1 and PC2 to be executed.

The second interface 23 is coupled (on demand) with the first device 8 and the second device 10 via the Internet (indicated by HTTPS) so that appropriate information and identification codes are available to access the SE 5A to 5C and to manage the vouchers stored therein on behalf of the service provider 2. For this purpose a method according to the invention is performed as explained below.

In FIG. 3 a block diagram of some basic elements of the mobile phone 4A is shown. For the sake of simplicity it is assumed that the mobile phones 4A to 4C have an identical structure. The mobile phone 4A comprises an over-the-air communication stage 30 for performing over-the-air communication OTAC, and a memory stage for storing e.g. said first digital voucher V1 and e.g. said first application 6A. In this particular embodiment of the invention the memory stage is realized as the secure element 5A that comprises a security domain for storing the first application 6A and the first voucher V1 and other vouchers or data as the case may be.

The first application 5A and the other two applications 5B and 5C are of identical design; hence they provide identical features when in operation. The first application 5A is designed, or in other words programmed, for sending a request via an over-the-air communication OTAC to the system 11 to transfer a part of the asset, represented by the first voucher V1, from the first member 3A of said voucher program to the second member 3B of said voucher program. Further to this, the application 6A is designed to block the first digital voucher V1 from being used until the request to transfer said part of said asset is successfully completed or terminated for other reasons. In order to include active human interaction in the process of transmitting the part of the asset, the application is also designed to receive an instruction from said system 11 to check if the recipient member is willing to accept to receive said part of the asset to be transferred and to perform said check and to return the result of the check to the system 11. This latter feature is of particular interest if the application is used on the second mobile phone 4B and 4C as will be explained in the context of the method according to the invention. Amongst these features explained in detail it should be clear to the skilled reader that other features may also be provided by the applications 6A to 6C.

For the sake of clarity and completeness it is to mention that the mobile phone 4A shown in FIG. 3 also comprises an NFC communication stage 31 for performing NFC based communication NFCC. The mobile phone 4A also comprises a processor stage 32 for performing the various processing activities required for its operation. The mobile phone 4A also comprises a user interface 33, e.g. in form of a touch sensitive display, which allows user interaction not only for phone operation but also for an operation of the application 6A. Between the various blocks of the mobile phone 4A data signals and/or command signals CS are exchanged during operation.

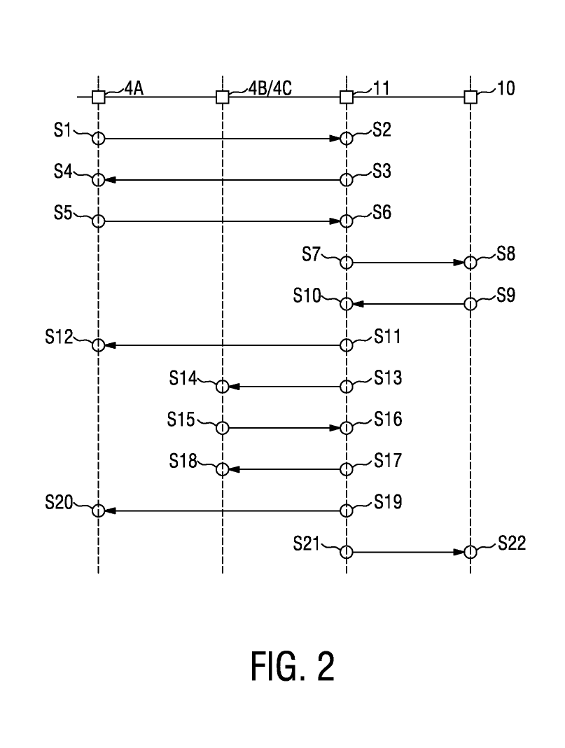

By means of FIG. 2, which visualizes a swim-flow diagram, the method of managing an asset presented by a digital voucher is explained.

Initially it is assumed that the first member 3A has received a digital first (original) voucher V1 indicated by a unique (original) first voucher identification code VC1. The first voucher identification code VC1 is registered at the second device 10 and represents a first (original) asset A1 of EUR 100.−. The first voucher identification code VC1 is stored together with a digital representation of the first asset A1 in the SE 5A of the first mobile phone 4A of the first member 3A so that the entire information can be visualized on the display (not shown) of the mobile phone 4A.

At the system 11 the link between the first member 3A and the first voucher V1 and the first asset A1 represented by the first voucher V1 is registered.

At the start of the method—first step S1—the first member 3A activates the first application 6A on its mobile phone 4A and selects a recipient from its contacts stored in its mobile phone 4A to receive a voucher present. By means of a user interface provided by the first application 6A the first member 3B selects the first voucher V1 and identifies the second member 3B by means of the phone number of the second member 3B as recipient member for an asset of EUR 20.− in form of a voucher. Said phone number is assigned to the second mobile phone 4B via the MNO 7.

The first mobile phone 4A communicates this request via its UMTS based over-the-air communication means 30 (see FIG. 3) to the OTA manager 9. Accordingly, at a second step S2 of the method the request to transfer a part (third-transfer-asset A3: EUR 20.−) of said original asset A1 of EUR 100.− of the first member 3A of said voucher program to the second member 3B of said voucher program is received at the system 11 via said over-the-air communication OTAC.

In general the step of receiving the request comprises collecting at least one first identification item to identify said first member 3A and collecting at least one second identification item to identify said second member 3B. In particular, in a third step S3, the system 11 contacts the application 6A in an over-the-air communication OTAC and requests detailed information regarding the transfer. The information is collected and prepared by the application 6A in a fourth step S4 and returned back to the system 11 in a further over-the-air communication OTAC in a fifth step S5, in which the phone number of the second member 3B, the first voucher identification code VC1, and the part (transfer asset A3: EUR 20.−) of the original asset A1 are provided.

In the following the system 11 performs a step of assigning a second digital voucher V2 to said first member 3A, wherein the second digital voucher V2 represents the remaining part of the asset of said first voucher V1, and assigning a third digital voucher V3 to said second member 3B, wherein the third digital voucher V3 represents said part of the asset requested to be assigned to the second member V3. Here the assigning is performed in cooperation with the service provider 2. The step of assigning is performed by the aid of the system 11 because at least the service provider 2 is also involved as explained below.

In this context, in a sixth step S6 performed at the system 11, the received information is evaluated and data are prepared to be suitable for the service provider 2 and in a seventh step S7 these data are submitted to the service provider 2 by means of an Internet based communication.

In an eighth step S8 at the second device 10 the request is executed by releasing a (new) second voucher identification code VC2 for a (new) second voucher V2, wherein the second voucher identification code VC2 is assigned to the first member 3A and the remaining part (remaining asset A2: EUR 80.−) of the original asset A1 of EUR 100.− is registered as second asset A2 that is represented by the second voucher V2. In the eighth step S8 at the second device 10 a (new) third voucher identification code VC3 for a (new) third voucher V3 is also released, wherein the third voucher identification code VC3 is assigned to the second member 3B, wherein the third voucher V3 represents said transfer asset A3, which is EUR 20.−, of the original asset A1 of EUR 100.−. Also at the system 11 the first voucher identification code VC1 is blocked from being used.

In a further, ninth step S9 the second device 10 returns data to the system 11 of the OTA manager 9, which data comprises the second voucher identification code VC2 and its link with the first member 3A as well as the second asset A2 of EUR 80.− represented by the second voucher V2, and the third voucher identification code VC3 and its link with the second member 3B as well as the transfer asset A3 of EUR 20.− represented by the third voucher V3. In a tenth step S10 the received data are evaluated at the system 11, which means information regarding the addressed first member 3A and the addressed second member 3B is extracted. Based on this information the first mobile phone 4A with its SE5 and the second mobile phone 4B with its SE 5B are identified. Also the appropriate data format to send data to and to store said data in the SE 5A and 5B is chosen.

Next, in an eleventh step S11 the system 11 communicates over-the-air OTAC with the first application 6A and as a consequence of this communication and data provided in the communication—in a twelfth step S12—the first application 6A sets the first voucher V1 in the first SE 5A in a status in which it is temporarily blocked from further use. Hence, the first voucher V1 is put in a pending status, which means that the asset of EUR 100.− is in the progress of being spent and confirmation of such spending is awaited. The pending status can only be left if the requested transfer of the part (transfer asset A3: EUR 20.−) of the original asset A1 is successfully completed (confirmed by the second application 6B) or terminated for other reasons. If it is successfully completed, the availability of the first voucher V1 is irrevocably cancelled. If termination for other reasons occurred, the availability of the first voucher V1 will be re-established by the first application 6A.

Similar to what was said in the preceding paragraph with regard to the first voucher V1 the second voucher V2 is stored in a pending status in the first SE 5A. Also for the second voucher V2 the roll back mechanism explained in the preceding paragraph applies, but with the difference that the second voucher V2 is deleted if the termination for other reasons occurs or the second voucher V2 is made available if the transfer is accomplished successfully.

More or less simultaneously to the eleventh step S11 the system 11 performs in a thirteenth step S13 an over-the-air communication OTAC with the second application 6B and informs the second application 6B, which in turn also informs the second member 3B in a fourteenth step S14 via the display of the second mobile phone 4B about the intention of the first member 3A to transfer a new voucher (the third voucher V3) that represents the transfer asset A3 of EUR 20.− as a present. The third voucher V3, or more particular the third voucher identification code VC3, is stored in the second SE 5B and put into a pending status, which means that the transfer asset A3 of EUR 20.− is in the progress of being transferred to the second member 3B. Again, the pending status can only be left if the requested transfer of the part (transfer asset A3) of the original asset A1 is successfully completed or terminated for other reasons. If it is successfully completed the third voucher V3 is made available for later spending. If termination for other reasons occurred, the third voucher V3 will be deleted in the second SE 5B by the second application 6B.

In a fifteenth step S15 the second member 3B confirms its willingness to accept the third voucher V3 via the user interface of the second mobile phone 4B and the second application 6B performs a further over-the-air communication OTAC with the system 11 in which a positive user reaction is communicated. In a sixteenth step S16 the positive user reaction is processed at the system 11 and via a further over-the-air communication OTAC the system 11 communicates an activation message to the second application 6B in a seventeenth step S17. In an eighteenth step S18 the activation message is received by the second mobile phone 4B and processed in the second application 6B. As a result the third voucher V3 is made available by the second application 6B in the second SE 5B for later spending.

Basically simultaneous to the seventeenth step S17, the system 11 generates a transaction finalization message in an nineteenth step S19 that is sent via an over-the-air communication OTAC to the first mobile phone 4A and processed by the first application 6A in a twentieth step S20 so that the first voucher V1 is irrevocably made non-available.

Thereafter, in a twenty-first step S21 the system 11 sends a validation message to the second device 10 of the service provider 2. In this validation message the service provider 2 is informed that the request to transfer said transfer asset A3 (EUR 20.−) of the original asset A1 (EUR 100.−) to the second member 3B was accomplished successfully by the mobile phones 4A and 4B. Hence, as a consequence of receiving this message, in a final twenty-second step S22 on the side of the service provider 2 the second voucher V2 is made available for spending by the first member 3A and the third voucher V3 is made available for spending by the second member 3B. Creating this availability comprises updating of the database available for the terminals (not depicted) of the service provider 2 where the second voucher V2 (EUR 80.−) and the third voucher V3 (EUR 20.−) can be spent or in other words consumed by the members 3A and 3B. Similar to the method described herein above, a further partial, dynamic phone-to-phone transfer of a part of the asset represented by the respective voucher V2 or V3 to other, further members (not depicted) is possible.

In a further embodiment of the method the step of checking if the second member is willing to accept to receive the third voucher may be implemented at an earlier stage of the method, e.g. after the step S6 or even after step S2. This may depend on the earliest moment at which an item to identify the second member is available.

In a further embodiment also the step of blocking the first voucher may be performed earlier when compared with the preceding embodiments. This step may be performed e.g. directly after step S2.

According to a further embodiment of the invention also a partial transfer of different assets represented by said first voucher V1 from the first member 3A to the second member 3B and the third member 3C can be performed. On the side of the first mobile phone 4A a group of recipients is selected from a list of contacts. Selection of the group of recipients is performed by selection of phone numbers of the mobile phones 4B and 4C of the two recipient members 3B and 3C and the two phone numbers are submitted via the over-the-air communication OTAC to the system 11. On the side of the system 11 the respective steps of the method according to the invention are performed for each individual recipient member 3B and 3C as it was explained for the preceding embodiment. By doing so, a first voucher V1 that represents an original asset A1 of e.g. EUR 100.− can be split into a second voucher V2 that represents an remaining asset A2 of e.g. EUR 50.−, which will be assigned to the first member 3A, a third voucher V3 that represents a first transfer asset A3 of e.g. EUR 30.−, which will be assigned to the second member 3B, and fourth voucher V4 that represents a second transfer asset A4 of e.g. EUR 20.−, which will be assigned to the third member 3C.

In the preceding embodiments the MNO 7 is the owner of the SEs 5A to 5C. However, in another embodiment also the owner of the SEs may be the OTA manager 9. Now the role of the MNO 7 is reduced to operating the mobile network only, while the access to the SEs 5A to 5C is controlled by the OTA manager. According to a further example also the service provider 2 may be the owner of the SEs 5A to 5C and consequently control access to them. In a further embodiment the service provider 2 may also operate the system 11 under its control, e.g. in-house. This may be performed by means of a trusted service provider software operated on a computer system of the service provider 2 or in form of an external trusted service provider organization operated on behalf or under control of the service provider 2. In a further embodiment also mobile phone manufacturers may be the owners of the SEs 5A to 5C and consequently control them and provide a trusted service provider service similar to the system 11. According to a further embodiment also a mixed mode of owners for the SEs 5A to 5C is possible. But also mixed modes of ownership may be possible.

A further embodiment of the invention is depicted in form of a further swim-flow diagram visualized in FIG. 5. and explained by means of a method of managing a digital original asset A1. In the following it is assumed that in the first mobile phone 4A a digital first asset A1 of Euro 100.− is securely stored in the first secure element 5A. The first mobile phone 4A is assigned to the first user 3A. The first user 3A desires to transfer a part of the original first asset A1, which part is equal to Euro 20.− and is herein termed transfer asset A3, to the second user 3B. Consequently a remaining asset A2 of Euro 80.− shall remain in the possession of the first user 3A. The second user 3B is the user of the second mobile phone 4B, which is assigned to the second user 3B. Said assets A1 to A3 are stored in the mobile phones 4A and 4B by means of data.

On the user interface of the first mobile phone 4A the first user 3A defines said transfer asset A3 of Euro 20.− and selects the second user 5B by identifying her/his mobile phone number. Data reflecting her/his desire to transfer said transfer asset A3 are sent in a first OTA communication T1 to the system 11.

Accordingly, the system 11 receives a request to transfer a part of the original first asset A1 from the first user 3A to the second user 3B. Triggered by this request, the system 11 performs according to the method of the invention by assigning the remaining part of the first asset A1—which is the remaining asset A2—to the first user 3A, and by assigning said part of the first asset to be transferred—which is the transfer asset A3—to the second user 3B.

By executing said method the system 11 performs a second OTA communication T2 with the first mobile phone 4A, in which the first secure element 5A is instructed to split the original asset A1 into said transfer asset A3 of Euro 20.− and said remaining asset A2 of Euro 80.−. In the first secure element 5A the transfer asset A3 is put into a pending state so that it is blocked from further use, while the remaining asset A2 is kept available for use. In a third OTA communication T3 the first mobile phone 4A communicates back to the system 11 that the transfer asset A3 was successfully put into said pending state.

Thereafter, in a fourth OTA communication T4 the system 11 sends a request to the second mobile phone 4B, in which the second user 3B is asked to confirm her/his willingness to receive the transfer asset A3 from the first user 3A. The second user utilizes the user interface of the second mobile phone 4B to enter her/his decision. If the second user 3B declines to receive the transfer asset A3, the system 11 communicates this information back to the first mobile phone 4A where the state of the transfer asset A3 is changed from pending back to available so that the original first asset A1 is reestablished. In contrast thereto, if the second user 3B confirms her/his willingness to accept the transfer asset A3, this decision is sent back to the system 11 in a fifth OTA communication T5. Upon processing the decision of the second user 3B, the system 11 sends a command to the second mobile phone 4B via a sixth OTA communication T6, wherein the command triggers the second secure element 5B to store the transfer asset A3. The second mobile phone 3B acknowledges the successful storage operation in a seventh OTA communication T7 with the system 11. If the acknowledgment is not received in a predetermined period, the system 11 rolls back the transfer operation on both mobile phones 4A and 4B, so that the original first asset A1 is made available on the first mobile phone 4A and, if necessary at all, any use of the transfer asset A3 on the second mobile phone 4B is avoided.

Based on the received acknowledgement at the system 11, the system 11 sends a message to the first mobile phone 4A via an eight OTA communication, in which message the transfer asset A3 is put into a void state or is even deleted. Consequently the pending (temporary) non-availability of the transfer asset A3 is changed into a permanent non-availability. Upon a successful change of the state of the transfer asset A3, the first mobile phone 4A returns a ninth OTA communication T9 to the system in which said change of state is acknowledged. Again, if the acknowledgment is not received in a predetermined period, the system 11 rolls back the transfer operation on both mobile phones 4A and 4B, so that the original first asset A1 is made available on the first mobile 3A and, if necessary at all, any use of the transfer asset A3 on the second mobile phone 3B is avoided.

As explained above, the first mobile device 4A performs a step of splitting the original first asset A1 in the second asset A2 and the third asset A3 and keeps the second asset A2, which is intended to replace the first asset A1, in a pending state until the storage of the third asset A3 in the second mobile device 4B is acknowledged.

In the preceding embodiment the operation of the involved devices 4A, 4B and 11 and the method performed was explained in terms of said digital assets—in fact a monetary asset in form of electronic cash represented digitally—the preceding embodiment may also be applied in the case of managing digital vouchers V1, V2, V3. In this case voucher identification codes, e.g. VC1 to VC3 are managed. As voucher identification codes VC1 to CV3 identify the asset A1, A2, A3, it is the preferred choice that the system 11 keeps control of the links between the voucher identification code VC1 to VC3 and the assets A1 to A3, while the voucher identification codes VC1 to VC3 are locally stored on the mobile devices e.g. 4A and 4B. Hence, once a transfer of a part of the first voucher V1 that is stored in the first mobile device 4A is requested, the system requests the first mobile phone 4A to put the first voucher identification code VC1 into a pending state in order to block it from being used. Only after the system 11 received a commitment from the second user 3B to accept to receive the part of the first voucher V1 to be transferred to her/him and the third voucher identification code VC3 was successfully stored in the second mobile device 4B, the system 11 assigns the second voucher V2 to the first mobile phone 4A, so that only the remaining part of the original first voucher remains available for further use for the first user 3A. Here, in contrast to the preceding example, the step of splitting the original first voucher V1 is performed by the system 11. Here the step of assigning is performed at the system 11 because it autonomously manages the distribution of the voucher identification codes.

Advantageously, the method performed avoids any loss or duplication of an asset or a voucher. In order to achieve this target the method checks if the second user is willing to accept to receive the part of the asset or the voucher intended for transfer to her or him and it is also checked if, for technical reasons, the assignment of parts of the asset or voucher failed.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the illustration enumerating several means, several of these means may be embodied by one and the same item. The mere fact that certain individual measures/features are recited in mutually different dependent claims does not indicate that a combination of these measures/features cannot be used to advantage.

1. A method of managing an asset, the method comprises the steps of:
receiving a request to transfer a part of a first asset from a first user to at least a second user at a system, wherein said request is received via an over-the-air communication with a first mobile device in which said first asset is stored, wherein the first mobile device is assigned to the first user, and
assigning by the aid of said system or at said system:
a remaining part of said first asset to the first user, and
said part of the first asset, which part was requested to be transferred, to the second user.

2. The method according to claim 1, wherein the step of assigning is performed:
independently by the system, or
in cooperation with a service provider.

3. The method according to claim 1, wherein the step of assigning comprises:
utilizing a unique digital first identification code of the first asset for a second asset, which first identification code is already assigned to the first user and said second asset is the remaining part of said first asset, or
utilizing a unique digital second identification code for the second asset, which second identification code is newly assigned to the first user, and
utilizing a unique third identification code for a third asset, which third identification code is newly assigned to the second user and the third asset is the part of the first asset to be transferred.

4. The method according to claim 1, wherein the step of assigning comprises blocking the first asset from being used until the request to transfer said part of said first asset is successfully completed or terminated for other reasons.

5. The method according to claim 1, wherein the step of assigning is accompanied by checking if the second user is willing to accept to receive said part of the first asset to be transferred, in particular said checking is performed preceding to the step of assigning or comprised in the step of assigning.

6. The method according to claim 1 that comprises the step of submitting from said system via an over-the-air communication with a second mobile device said third asset to a second mobile device and storing it in the second mobile device, wherein the second mobile device is assigned to the second user.

7. The method according to claim 1, wherein the step of receiving said request comprises collecting at least one first identification item to identify said first user.

8. The method according to claim 1, wherein the step of assigning comprise collecting at least one second identification item to identify said second user.

9. The method according to claim 7, wherein said identification item is selected from: a mobile device identification code, an application identification code, a secure element identification code, user identification code.

10. A system for managing an asset, the system comprises:
an interface stage for receiving a request to transfer a part of a first asset from a first user to a second user, wherein said request is received via an over-the-air communication with a first mobile device, in which said first asset is stored, wherein the first mobile device is assigned to the first user, and
an assignment stage for assigning:
a remaining part of said first asset to the first user, and
said part of the first asset, which part was requested to be transferred to the second user.

11. The system according to claim 10, wherein the assignment stage is designed to perform the assignment independently or in cooperation with a service provider.

12. A mobile device, in particular a mobile phone, for storing an asset, the mobile device comprises:
an over-the-air communication stage for performing over-the-air communication, and
a memory stage for storing
a first asset, and
an application for sending a request to transfer a part of said first asset from a first user to a second user, wherein said request is sent via an over-the-air communication to a system.

13. The mobile device according to claim 12, wherein the memory stage is realized as secure element.

14. The mobile device according to claim 12, wherein the application is designed to block the first asset from being used until the request to transfer said part of said asset is successfully completed or terminated for other reasons.

15. The mobile device according to claim 12, wherein the application is designed to receive from said system an instruction to check if the second member is willing to accept to receive said part of the asset to be transferred and to perform said check and to return the result of the check to the system.
